(19) United States
(12) Patent Application Publication
(10) Pub. No.: US 2006/0194557 A1
(43) Pub. Date: Aug. 31, 2006

(54) Tuner

(76) Inventors: Nicholas Paul Cowley, Wiltshire (GB); Peter Coe, Cricklade (GB)

Correspondence Address: Keith M. Tackett;PATTERSON & SHERIDAN, L.L.P., Suite 1500, 3040 Post Oak Blvd., Houston, TX, 77056, US

(21) Appl. No.: 11/351,320

(22) Filed: Feb. 9, 2006

(30) Foreign Application Priority Data
Feb. 10, 2005 (GB) 0502667.9

(51) Int. Cl. H04B 1/06; H04B 1/26

(52) U.S. Cl. 455/313; 455/277.1

(57) ABSTRACT

A tuner is provided for permitting independent reception of a plurality of channels from a multiple channel radio frequency input signal. A first analog converter of the upconverter type block-converts the radio frequency band to an intermediate frequency band. Several second analog frequency converters, such as quadrature ZIF downconverters, are independently controllable for independently selecting respective channels for reception from the intermediate frequency band at the output of the first converter. Each of the second converters converts the respective selected channel to the desired intermediate frequency. A voltage-driven interface is provided between the first converter and the second converters.

### BACKGROUND OF THE INVENTION

1. Field of the Invention

The present invention relates to a tuner. Such a tuner may be used, for example, in a digital cable reception system or in a terrestrial system, such as a set-top box.

2. Description of the Related Art

There is a desire, for example in digital cable set-top boxes, to provide support for multiple channel reception. Such support may be required to provide, for example, Personal Video Recorder (PVR) picture-in-picture, or a plurality of independent “access” devices from a common receiver terminal. Each reception channel requires a radio frequency tuner whose function is to receive and select a desired channel from a radio frequency band and to convert the selected channel to a desired intermediate frequency for supplying to a digital demodulator.

Known tuners such as television tuners are typically of single conversion or double conversion type. Both such types are well known and will not be described further.

FIG. 1 of the accompanying drawings illustrates a typical single tuner arrangement for receiving a single channel at a time from a cable distribution network. This arrangement comprises a radio frequency input 11 for connection to a cable feed. The input 11 is connected via a diplexer 12 to a tuner 13 of conventional type. The diplexer 12 is of conventional type and comprises a filter arrangement for passing the downstream channels, typically in the frequency range 55 to 860 MHz from the cable feed to the tuner 13 and for passing upstream channels, typically in the frequency range 5 to 45 MHz from a local receiver transmitter to the cable feed. The diplexer 12 also provides isolation between the tuner 13 and the receiver transmitter (not shown).

In order to provide independent reception of two channels, two independently controllable tuners are conventionally required. However, it is not possible simply to connect two such tuners in parallel to a cable feed so that an interface function has to be provided and a suitable arrangement is illustrated in FIG. 2 of the accompanying drawings.

The arrangement shown in FIG. 2 differs from that shown in FIG. 1 in that a power splitter 24 is disposed between the diplexer 22 and two tuners 23A and 23B. The power splitter 24 provides independent outputs to the tuners 23A and 23B, which operate independently of each other to provide simultaneous independent selection of two channels for reception.

Such an arrangement has the disadvantage that the power splitter 24 may degrade the signal-to-noise plus intermodulation (S/N+I) performance of the arrangement or may place more stringent performance demands on the tuners 23A and 23B. This is because of the presence of a further active stage in the form of the power splitter 24 which may contribute to the noise and intermodulation of the arrangement. In particular, in such “cascaded” systems, all of the stages contribute to the noise and intermodulation of the system. The gain of the first stage, in this case, the power splitter 24, is generally maximised in order to minimise the noise contribution from the following stages, in this case, the tuners 23A and 23B. However, this increases the signal level supplied to each of the tuners and may therefore degrade the tuner intermodulation performance. Conversely, if a lower first stage gain is used so as to cause less intermodulation, the noise contribution of the following stages is increased and thus degrades the noise performance of the system.

In such a two channel system, the power amplifier in the power splitter 24 is required to provide sufficient gain to allow for the power splitting function and to provide noise protection from the following tuners. The power loss to each output of the power splitter 24 is at least 3 dB (assuming a loss-less power splitting function). In order to minimise noise contribution, a typical gain is approximately 3 to 5 dB. If a high gain is provided, the intermodulation contribution from the tuners 23A and 23B increases unless the power consumption of the tuners is increased to accommodate the higher input signal levels.

If the number of independently receivable channels is increased, the power loss in the power splitter 24 also increases and, in order to compensate for this, the power amplifier gain must be increased to maintain the desired gain through the power splitter 24 and the tuners connected to it. However, as the gain is increased within the supply voltage and power restrictions of a typical application, it becomes increasingly difficult to maintain an acceptable intermodulation performance within the power amplifier, which thus contributes to the intermodulation of the system. For example, if the number of tuners is increased from two to four, then the voltage swing at the power amplifier output will be doubled. This increased voltage swing may result in increased intermodulation, for example because of relatively large signal collector parasitic non-linearities. Also, there may be insufficient headroom in the power amplifier to provide a sufficiently large voltage swing so that, for example, a higher power supply voltage and hence higher power consumption would be required.

Increasing the power amplifier gain may also affect other aspects of performance, such as the consistency of flatness of gain across the frequency range handled by the power splitter 24. This effect may result in an increase in intermodulation levels for channels which are subjected to less gain and may also degrade the noise figure for such channels.

Although several stages of power splitting could be provided to increase the number of channels which may be received, such an arrangement does not overcome the problems. For example, where one power splitting stage is followed by two further power splitting stages, problems exist in achieving the required overall S/(N+I) performance because there would be three stages contributing to noise and intermodulation.

US 2004/0218700 discloses a digital multi-channel demodulator arrangement. An analog downconverter converts a plurality of radio frequency channels to a lower frequency band such that the downconverted signal can be converted to the digital domain by an available analog-digital converter. The digital signal is supplied to a digital channel demultiplexer, which makes the channels available for further processing. A selector selects which channels are to be received and supplies these to respective digital demodulators.

Although such an arrangement allows several channels to be received simultaneously, it has various disadvantages. For example, where the analog-digital converter sampling rate is greater than the frequency being sampled, the highest frequency which may be supplied to the analog-digital converter must be less than half the sampling rate of the converter. This limits the frequency band which can be processed, typically to much less than a multi-channel cable or broadcast band. Only channels which are within the down-converted part of the band can be received simultaneously. The choice of channels for simultaneous reception is therefore restricted as it is impossible to receive simultaneously channels which are separated in frequency by more than half the converter sampling rate.

### SUMMARY OF THE INVENTION

According to a first aspect of the invention, there is provided a tuner comprising an input for receiving a multiple channel input signal in a radio frequency band, a first frequency upconverter for upconverting the radio frequency band to a higher intermediate frequency band, and a plurality of second frequency converters for selecting, independently of each other, respective channels in the intermediate frequency band for reception, each of the second frequency converters being arranged to convert the respective selected channel to an intermediate frequency.

The first and second frequency converters may be analog frequency converters.

The tuner may comprise a voltage-driven interface between the first frequency converter and the second frequency converters.

According to a second aspect of the invention, there is provided a tuner comprising an input for receiving a multiple channel input signal in a radio frequency band; a first frequency converter for converting the radio frequency band to an intermediate frequency band, a plurality of second frequency converters for selecting, independently of each other, respective channels in the intermediate frequency band, each of the second frequency converters being arranged to convert the respective selected channel to an intermediate frequency, and a voltage-driven interface between the first frequency converter and the second frequency converters.

The first frequency converter may be an upconverter.

The first and second frequency converters may be analog frequency converters.

According to a third aspect of the invention, there is provided a tuner comprising an input for receiving a multiple channel input signal in a radio frequency band, a first analog frequency converter for converting the radio frequency band to an intermediate frequency band, and a plurality of second analog frequency converters for selecting, independently of each other, respective channels in the intermediate frequency band, each of the second frequency converters being arranged to convert the respective selected channel to an intermediate frequency.

The tuner may comprise a voltage-driven interface between the first frequency converter and the second frequency converters.

The first frequency converter may be an upconverter.

The intermediate frequency band may have a lower frequency limit which is higher than an upper frequency limit of the radio frequency band.

The second frequency converters may be arranged to convert the respective selected channels to the same intermediate frequency.

At least one of the second frequency converters may be a downconverter. All of the second frequency changers may be downconverters. At least one of the second frequency converters may be a zero or near zero intermediate frequency converter. At least one of the second frequency converters may be a quadrature converter.

At least one of the second frequency converters may include an image reject mixer.

The tuner may comprise a fixed first bandlimit filter between the input and the first frequency converter.

The tuner may comprise a second fixed bandlimit filter between the first frequency converter and the second frequency converter.

The tuner may comprise a respective filter between each of the second frequency converters and the first frequency converter. Each respective filter may be arranged to track the frequency of a local oscillator of a respective one of the second frequency converter. Each respective filter may be substantially identical to a resonator of the local oscillator of the respective second frequency converter.

The first frequency converter may be arranged to perform fixed frequency conversion. As an alternative, the first frequency converter may be arranged to perform variable frequency conversion for avoiding interference from spurious products.

### BRIEF DESCRIPTION OF THE DRAWINGS

FIG. 1 is a block schematic diagram of a known cable reception arrangement;

FIG. 2 is a block schematic diagram of a known two channel cable reception arrangement;

FIG. 3 is a block schematic diagram of a reception arrangement including a tuner consisting an embodiment of the invention;

FIG. 4 is a block diagram of an upconverter of the tuner shown in FIG. 3;

FIG. 5 is a block diagram of each downconverter of the tuner shown in FIG. 3.

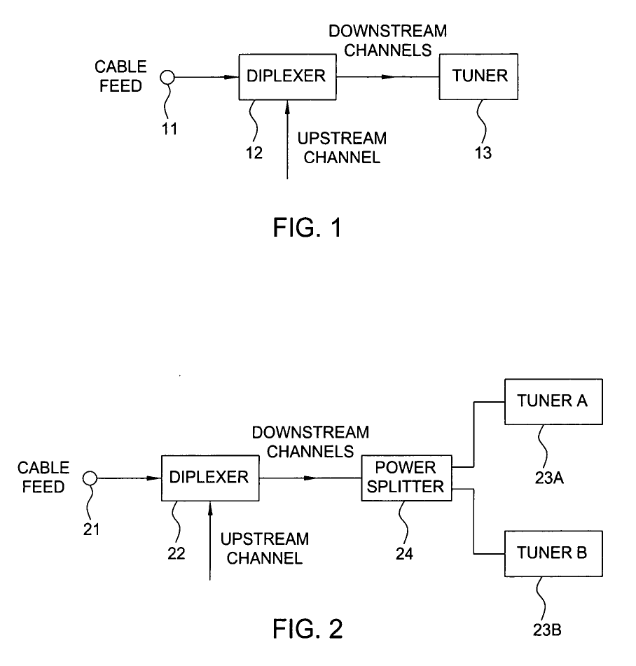

### DETAILED DESCRIPTION

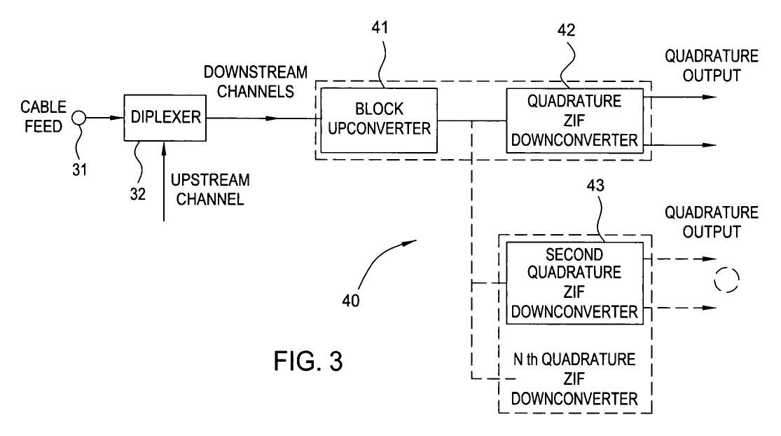

The arrangement shown in FIG. 3 is intended for use with a cable distribution system for supplying multiple digital television and/or radio and/or data channels. However, such an arrangement is also suitable for other applications, such as terrestrial or satellite reception. Such an arrangement is very suitable for “upintegration” and may readily be implemented on a motherboard.

The arrangement comprises an input 31 and a diplexer 32 as described hereinbefore. The output of the diplexer 32 is connected to the input of a tuner 40 for simultaneously and independently receiving N channels from the multiple channel radio frequency signal supplied to the input 31 from the cable feed.

The tuner 40 comprises an analog block upconverter 41 whose input is connected to the output of the diplexer 32. The upconverter 41 performs block upconversion of the input signal to a higher intermediate frequency band. The upconversion is such that the frequency of the lowest frequency channel after conversion is higher than the frequency of the highest frequency channel before conversion. The upconverter 41 may perform fixed upconversion so that the whole of the input frequency band is shifted in frequency to a fixed higher intermediate frequency band. However, it is possible that interactions may occur between, for example, local oscillators in the upconverter 41 and in other converters described hereinafter resulting in spurious mixing products within the tuner output frequency band, for example because of mixing of harmonics. It is therefore possible for the upconverter 41 to perform variable upconversion and for subsequent downconvertors to be adjusted appropriately, when selecting desired channels, so as to avoid interference because of such spurious mixing products.

The output of the upconverter 41 is supplied to the inputs in parallel of N analog quadrature zero intermediate frequency (ZIF) downconverters such as 42 and 43. The downconverters are all illustrated in this embodiment as being of zero intermediate frequency (ZIF) type but other types or mixtures of types may be used. For example, at least one of the downconverters may be of near zero intermediate frequency (NZIF) type. Low IF and conventional IF downconverters may also be used depending on the requirements of the specific application. Also the downconverters may include image reject mixers.

Each of the downconverters is controllable independently of the other downconverters to allow simultaneous independent selection of N channels for reception. Each of the downconverters supplies baseband in-phase (I) and quadrature (Q) output signals, for example to a respective demodulator (not shown). The block upconverter 41 provides a voltage-driven output interface to the downconverters 42, 43.

The received signal handling stages of the upconverter 41 and the downconverters 42, 43 operate in the analog domain. Conversion to the digital domain, if appropriate for the application of the tuner, may be performed by analog-digital converters downstream of one or more of the downconverters 42, 43.

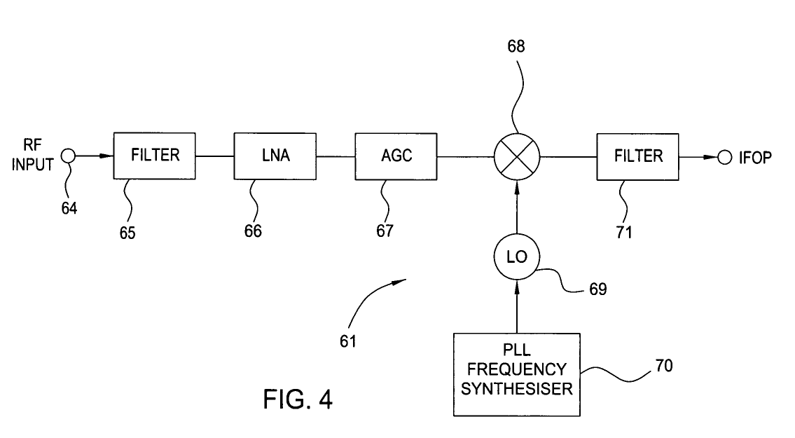

The upconverter 41 is shown in more detail in FIG. 4 and comprises an input bandlimit filter 65 connected to a radio frequency (RF) input 64. The filter 65 is of fixed or non-tuneable type and is arranged to pass the whole of the desired band for reception while attenuating out-of-band signal energy. The output of the filter 65 is supplied to a low noise amplifier (LNA) 66, whose output is supplied to an automatic gain control (AGC) circuit 67. The output of the circuit 67 is applied to a first input of a mixer 68, whose second input is connected to the output of a local oscillator (LO) 69. The local oscillator 69 may be of fundamental or harmonic implementation and is controlled by a phase locked loop (PLL) frequency synthesiser 70. As described herein before, the synthesiser may control the frequency of the oscillator 69 to be fixed or may vary the frequency to avoid interference from spurious mixing products.

The output of the mixer 68 in the intermediate frequency range is supplied to a bandlimit filter 71. The filter 71 may, for example, be of the fixed or non-variable type and is arranged to pass the intermediate frequency band while attenuating out-of-band signal energy, such as undesirable mixing products from the mixer 68. In an alternative embodiment, the filter 71 may be omitted.

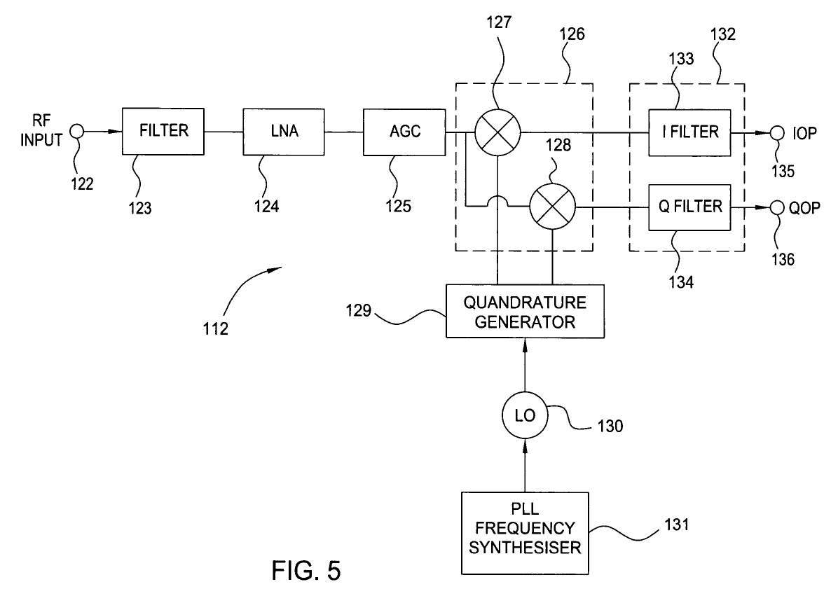

The downconverter 42 of FIG. 3, is shown in more detail in FIG. 5 and comprises an RF input 122 for receiving the channels in the intermediate frequency range from the upconverter 41. The intermediate frequency signal is supplied to a bandlimit filter 123 which may be of fixed type or may be variable, continuously or step-wise, so as to track the frequency of the selected channel. The output of the filter is supplied to an LNA 124, whose output is supplied to an AGC circuit 125. In alternative embodiments, the filter 123 and/or the AGC circuit 125 may be omitted.

The output of the circuit 125 is applied to a quadrature mixer 126 comprising individual mixers 127 and 128 for providing the I and Q ZIF output signals of the mixer. The mixers 127 and 128 receive quadrature commutation signals from a quadrature generator 129. The generator 129 receives a local oscillator signal from the oscillator 130, which is controlled by a synthesiser 131.

Because the downconverter is of the zero intermediate frequency type, the frequency of the commutation signals is equal to the channel centre frequency of the selected channel in the intermediate frequency range. The synthesiser 131 is controlled so as to permit the selection of any desired channel present at the input 122. The local oscillator 130 may comprise a resonator which is substantially identical to the filter 123 and this allows an alignment-free arrangement to be provided. For example, where the tuner is embodied by a single monolithic integrated circuit, the filter 123 and the resonator of the oscillator 130 can be relatively accurately matched in terms of resonant or centre frequency so that no alignment during or after manufacture or during use is required. Alternatively but similarly, the filter and the oscillator may be embodied with components of harmonically related component values to provide an alignment-free arrangement.

The outputs of the mixers 127 and 128 are supplied to respective filters 133 and 134 of a quadrature low pass filter 132. The turnover frequencies of the filters 133 and 134 may be the same and may be fixed or may be variable so as to adapt the filter performance to the bandwidth of the received channel. The I and Q outputs of the filter 132 are supplied to quadrature outputs 135 and 136 for subsequent demodulation and/or other processing.

Any number of downconverters such as 42 and 43 may be connected to the output of the upcoverter 41 to provide any number of independently selectable channels for simultaneous reception. Signal splitting for independent channel reception is performed within the tuner between the upconverter 41 and the downconverters such as 42 and 43. The interface between the converter 41 and converters 42, 43 is voltage driven (as opposed to being power-matched) and this assists in the minimisation of noise contribution from the downconverters. In particular, voltage drive does not result in any power loss, which would happen in a power-matched interface. Provided the effective input impedances of the converters 42, 43 are sufficiently higher than the output impendence of the converter 41, any number of downconverters may be connected to the upconverter 41 without significant reduction in input voltage to each downconverter.

Band conversion to a higher frequency effectively removes or substantially reduces second-order related distortions and this allows more gain to be applied upstream of the downconverters in order to minimise the noise contribution by the downconverters. Although third order distortions may not be substantially affected, it is generally easier to provide good third order intermodulation performance so that a satisfactory intermodulation performance can be achieved and is not comprised by the tuner architecture.

By providing the variable or tracking filters 123 between each downconverter and the upconverter, the composite signal power and number of channels supplied to the mixer 126 of each downconverter can be reduced. This permits a reduction in third order intermodulation generation and has benefits for harmonic noise contribution.

While the foregoing is directed to embodiments of the present invention, other and further embodiments of the invention may be devised without departing from the basic scope thereof, and the scope thereof is determined by the claims that follow.

1. A tuner comprising:
an input for receiving a multiple channel input signal in a radio frequency band;
a first frequency upconverter for upconverting said radio frequency band to a higher intermediate frequency band; and
a plurality of second frequency converters for selecting, independently of each other, respective channels in said intermediate frequency band, wherein each of said second frequency converters are arranged to convert said respective selected channel to an intermediate frequency.

2. A tuner as claimed in claim 1, wherein said first and second frequency converters are analog frequency converters.

3. A tuner as claimed in claim 1, further comprising a voltage-driven interface between said first frequency converter and said second frequency converters.

4. A tuner as claimed in claim 1, wherein said intermediate frequency band has a lower frequency limit which is higher than an upper frequency limit of said radio frequency band.

5. A tuner as claimed in claim 1, wherein said second frequency converters are arranged to convert said respective selected channels to a same said intermediate frequency.

6. A tuner as claimed in claim 1, wherein at least one of said second frequency converters is a downconverter.

7. A tuner as claimed in claim 1, wherein all of said second frequency converters are downconverters.

8. A tuner a claimed in claim 6, wherein at least one of said second frequency converters is a zero intermediate frequency converter or a near-zero intermediate frequency converter.

9. A tuner as claimed in claim 6, wherein at least one of said second frequency converters is a quadrature converter.

10. A tuner as claimed in claim 1, wherein at least one of said second frequency converters includes an image reject mixer.

11. A tuner as claimed in claim 1, further comprising a fixed bandlimit filter between said input and said first frequency converter.

12. A tuner as claimed in claim 1, further comprising a fixed bandlimit filter between said first frequency converter and said second frequency converters.

13. A tuner as claimed in claim 1, further comprising a respective filter between each of said second frequency converters and said first frequency converter.

14. A tuner as claimed in claim 13, wherein each of said second frequency converters comprises a respective local oscillator and each said respective filter is arranged to track a frequency of said respective local oscillator.

15. A tuner as claimed in claim 14, wherein each said respective local oscillator comprises a resonator and each said respective filter is substantially identical to said resonator of said respective local oscillator.

16. A tuner as claimed in claim 1, wherein said first frequency converter is arranged to perform fixed frequency conversion.

17. A tuner as claimed in claim 1, wherein said first frequency converter is arranged to perform variable frequency conversion for avoiding interference from spurious products.

18. A tuner comprising:
an input for receiving a multiple channel input signal in a radio frequency band;
a first frequency converter for converting said radio frequency band to an intermediate frequency band;
a plurality of second frequency converters for selecting, independently of each other, respective channels in said intermediate frequency band, wherein each of said second frequency converters are arranged to convert said respective selected channel to an intermediate frequency; and
a voltage-driven interface between said first frequency converter and said second frequency converter.

19. A tuner as claimed in claim 18, wherein said first and second frequency converters are analog frequency converters.

20. A tuner as claimed in claim 18, wherein said first frequency converter is an upconverter.

21. A tuner as claimed in claim 20, wherein said intermediate frequency band has a lower frequency limit which is higher than an upper frequency limit of said radio frequency band.

22. A tuner as claimed in claim 18, wherein said second frequency converters are arranged to convert said respective selected channels to a same said intermediate frequency.

23. A tuner as claimed in claim 18, wherein at least one of said second frequency converters is a downconverter.

24. A tuner as claimed in claim 18, wherein all of said second frequency converters are downconverters.

25. A tuner a claimed in claim 23, wherein at least one of said second frequency converters is a zero intermediate frequency converter or a near-zero intermediate frequency converter.

26. A tuner as claimed in claim 23, wherein at least one of said second frequency converters is a quadrature converter.

27. A tuner as claimed in claim 18, wherein at least one of said second frequency converters includes an image reject mixer.

28. A tuner as claimed in claim 18, further comprising a fixed bandlimit filter between said input and said first frequency converter.

29. A tuner as claimed in claim 18, further comprising a fixed bandlimit filter between said first frequency converter and said second frequency converters.

30. A tuner as claimed in claim 18, comprising a respective filter between each of said second frequency converters and said first frequency converter.

31. A tuner as claimed in claim 30, wherein each of said second frequency converters comprises a respective local oscillator and each said respective filter is arranged to track a frequency of said respective local oscillator.

32. A tuner as claimed in claim 31, wherein each said respective local oscillator comprises a resonator and each said respective filter is substantially identical to said resonator of said respective local oscillator.

33. A tuner as claimed in claim 18, wherein said first frequency converter is arranged to perform fixed frequency conversion.

34. A tuner as claimed in claims 18, wherein the first frequency converter is arranged to perform variable frequency conversion for avoiding interference from spurious products.

35. A tuner comprising:
an input for receiving a multiple channel input signal in a radio frequency band;
a first analog frequency converter for converting said radio frequency band to an intermediate frequency band; and
a plurality of second analog frequency converters for selecting, independently of each other, respective channels in said intermediate frequency band, wherein each of said second frequency converters are arranged to convert said respective selected channel to an intermediate frequency.

36. A tuner as claimed in claim 35, further comprising a voltage-driven interface between said first frequency converter and said second frequency converters.

37. A tuner as claimed in claim 35, wherein said first frequency converter is an upconverter.

38. A tuner as claimed in claim 37, wherein said intermediate frequency band has a lower frequency limit which is higher than an upper frequency limit of said radio frequency band.

39. A tuner as claimed in claim 35, wherein said second frequency converters are arranged to convert said respective selected channels to a same said intermediate frequency.

40. A tuner as claimed in claim 35, wherein at least one of said second frequency converters is a downconverter.

41. A tuner as claimed in claim 40, wherein all of said second frequency converters are downconverters.

42. A tuner a claimed in claim 40, wherein at least one of said second frequency converters is a zero intermediate frequency converter or a near-zero intermediate frequency converter.

43. A tuner as claimed in claim 40, wherein at least one of said second frequency converters is a quadrature converter.

44. A tuner as claimed in claim 35, wherein at least one of said second frequency converters includes an image reject mixer.

45. A tuner as claimed in claim 35, further comprising a fixed bandlimit filter between said input and said first frequency converter.

46. A tuner as claimed in claim 35, further comprising a fixed bandlimit filter between said first frequency converter and said second frequency converters.

47. A tuner as claimed in claim 35, further comprising a respective filter between each of said second frequency converters and said first frequency converter.

48. A tuner as claimed in claim 47, wherein each of said frequency converters comprises a respective local oscillator and each said respective filter is arranged to track a frequency of said respective local oscillator.

49. A tuner as claimed in claim 48, wherein each said respective local oscillator comprises a resonator and each said respective filter is substantially identical to said resonator of said respective local oscillator.

50. A tuner as claimed in claim 35, wherein said first frequency converter is arranged to perform fixed frequency conversion.

51. A tuner as claimed in claim 35, wherein said first frequency converter is arranged to perform variable frequency conversion for avoiding interference from spurious products.
